(19) United States
(12) Patent Application Publication
(10) Pub. No.: US 2014/0267438 A1
(43) Pub. Date: Sep. 18, 2014

(54) SCALING AN IMAGE HAVING TEXT

(71) Applicant: APPLE INC., Cupertino, CA (US)

(72) Inventor: Joseph W. SOSINSKI, Mountain View, CA (US)

(73) Assignee: Apple Inc., Cupertino, CA (US)

(21) Appl. No.: 13/802,126

(22) Filed: Mar. 13, 2013

(51) Int. Cl. G06T 3/40

(52) U.S. Cl. CPC G06T 3/40
USPC 345/666

(57) ABSTRACT

Methods of scaling an image having text are provided. An image having text may be obtained. A size of the text in the image may be obtained. In some examples, optical character recognition (OCR) and/or related techniques may be used to determine a font size or an average character height. A proper scaling factor may be determined based on the size of the text, and the image can be displayed scaled such that the text may be large enough to be legible.

### FIELD OF THE DISCLOSURE

This relates generally to a visual scaling operation on an electronic device.

### BACKGROUND OF THE DISCLOSURE

Electronic devices with displays are increasingly used to view documents, web pages, books, and other media that may contain text and images. Scaling can be used to increase or decrease the visual size of such text and images on a display of an electronic device. However, a scaling operation may not scale text such that it is legible to a user.

### SUMMARY OF THE DISCLOSURE

Various examples are related to methods of scaling an image having text. An image having text may be obtained. A size of the text in the image may be obtained. In some examples, optical character recognition (OCR) and/or related techniques may be used to determine a font size or an average character height. A proper scaling factor may be determined based on the size of the text, and the image can be displayed scaled such that the text may be large enough to be legible.

### BRIEF DESCRIPTION OF THE DRAWINGS

FIG. 1A illustrates an exemplary display of an image according to embodiments of the disclosure.

FIG. 1B illustrates an exemplary scaled image according to embodiments of the disclosure.

FIG. 1C illustrates an exemplary scaled image according to embodiments of the disclosure.

FIG. 2 illustrates an exemplary method of scaling an image having text according to examples of the disclosure.

FIG. 3 is a block diagram illustrating an exemplary API architecture, which may be used in some examples of the disclosure.

FIG. 4 illustrates an exemplary software stack of an API according to examples of the disclosure.

FIG. 5 is a block diagram illustrating exemplary interactions between the touch screen and the other components of the device according to examples of the disclosure.

FIG. 6 is a block diagram illustrating an example of a system architecture that may be embodied within any portable or non-portable device according to examples of the disclosure.

### DETAILED DESCRIPTION

In the following description of examples, reference is made to the accompanying drawings which form a part hereof, and in which it is shown by way of illustration specific examples that can be practiced. It is to be understood that other examples can be used and structural changes can be made without departing from the scope of the disclosed examples.

Various examples are related to methods of scaling an image having text. An image having text may be obtained. A size of the text in the image may be obtained. In some examples, optical character recognition (OCR) and/or related techniques may be used to determine a font size or an average character height. A proper scaling factor may be determined based on the size of the text, and the image can be displayed scaled such that the text may be large enough to be legible.

Although examples disclosed herein may be described and illustrated herein primarily in terms of scaling images, it should be understood that the examples are not so limited, but are additionally applicable to methods of scaling other content, such as documents and web pages, that may include images and text.

A scaling operation can be used on an electronic device to increase and/or decrease the apparent size of content on a display based on a scaling factor. For example, scaling by a scaling factor of 2 can make an image appear twice as large, whereas scaling by a scaling factor 0.5 can make an image appear half as large. In some examples, a user can select a desired scaling factor by adjusting a user interface control or by performing a gesture.

In other examples, a scaling factor can be automatically chosen by the electronic device. For example, a scaling factor of 2 may be chosen as a default for any scaling operation. If the scaling operation is performed on content such as an image or a block of text, the scaling factor may be chosen based on the dimensions of the content. For example, the scaling factor may be chosen such that, after scaling, the width of a block of text on the display is equal to or slightly less than the width of the display. In some examples, a scaling factor may be chosen such that, after scaling, the content fills the display without exceeding its bounds.

In some examples, an image may contain text, and a scaling factor may be chosen based on the size of the text in the image, such that, after scaling, the text in the image may appear legible. OCR and/or related techniques may be used to determine the size of the text in the image. In some cases, the individual characters need not be recognized. Instead, the scaling factor may be based merely on a determination that text is present in the image and an estimate of the size of the text, such as a font size or an average character height.

Such an operation can be useful, for example, in scaling an image of a comic book page. As the display progresses from panel to panel of the comic book page, the scaling factor can be adjusted automatically based on the size of the text in the panel. For example, the scaling factor can be adjusted based on the size of the smallest text in the panel, such that all the text in the panel can appear legible to the user. Additionally, the method may only perform localized character recognition to only recognize blocks of text and determine text size in a portion of the image to be scaled, conserving processing resources.

FIG. 1A illustrates an exemplary display of an image according to embodiments of the disclosure. The displayed image 100 includes text 102, 104, 106, 108, 110, and 112. In some examples, a user may select a portion of the image to be scaled. For example, a user may select a portion of the image using a pointing device or by performing a gesture on a touch screen, such as a tap or double tap, in the desired portion of the image. In some examples, a scaling focus may be set based on user input from a pointing device or touch screen, and the scaling factor may be determined based only upon text within a certain radius of the scaling focus. In other examples, a scaling focus may be predefined to a certain location on an image, or to the center of the image, among other possibilities.

FIG. 1B illustrates an exemplary scaled image according to embodiments of the disclosure. In FIG. 1B, the portion of the image to be scaled includes some or all of text 106, 110, and 112. The size of some or all of text 106, 110, and 112 may be determined, and a scaling factor may be determined based on the size. For example, the average character height of text 106 may be determined without identifying the individual characters that make up text 106. Additionally, the average character height of text 112 may be determined and compared to the average character height of text 106. Based on a determination that the average character height of text 106 is smaller than the average character height of text 112, the scaling factor may be determined based only on the average character height of text 106. In some examples, the size of text 112 may not be determined at all because most of text 112 is outside the portion of the image 100 to be scaled.

FIG. 1C illustrates an exemplary scaled image according to embodiments of the disclosure. In FIG. 1C, the portion of the image to be scaled includes some or all of text 104 and 108. In some examples, the scaling factor may be determined based on only a size of text 104 if it is determined that text 108 is outside a certain radius of a scaling focus. In other examples, the scaling factor may be determined based on only a size of text 108 if the size of text 108 is smaller than the size of text 104.

FIG. 2 illustrates an exemplary method of scaling an image having text according to examples of the disclosure. An image having text may be obtained (200). For example, the image may be obtained from a storage medium of an electronic device. In some examples, the image may be downloaded from a remote device via a network such as the Internet. The image may also be obtained as part of or in accordance with content such as a document or a web page.

In some examples, an image having text may only contain a visual representation of the text. That is, the text may not be stored in a character-encoding scheme such as American Standard Code for Information Interchange (ASCII). Additionally, the text may be present in the image without formatting information such as the size of the text. The text in the image may have been photographed or printed and scanned. In some examples, the text in the image may have been created by an electronic device and then rasterized into a bitmap.

A size of the text in the image may be obtained (202). Without stored text size information or related formatting information that can be used to trivially obtain text size, the image may be processed using OCR and/or related techniques to obtain a size of the text. A size of the text may include an estimated font size or an average character height, among other possibilities.

In some cases, the image may be processed to determine a size of the text in response to a scaling command. In other cases, the image may be processed in anticipation of a scaling command to determine a size of the text. For example, if a user is viewing an image slideshow in a gallery, images adjacent to the currently viewed image may be processed to obtain a size of the text in those images. In another example, as a first portion of an image is displayed, adjacent portions of the same image may be processed to obtain a size of the text in those portions in anticipation of a scaling command on those portions.

A scaling factor can be determined based on the size of the text (204). Determining the scaling factor may be further based on a desired text size. For example, if the average character height of the text is 8 pixels and a desired text size is 16 pixels, then the scaling factor can be 2, the ratio of the desired text size to the average character height of the text. The desired text size may be determined based on one or more properties of the display, such as resolution, pixel density, and physical size, among other possibilities. In some examples, the desired text size may be further based on a legibility factor that may be set by a user to quantify the quality of the user's eyesight. For example, a user with poor eyesight may set a higher legibility factor than a user with adequate eyesight, resulting in a larger desired text size.

The image can be displayed scaled based on the scaling factor (206). Because the scaling factor can be determined based on the size of the text in the image and a desired text size, the text in the scaled image can be the desired size and thus legible to a user.

The examples discussed above can be implemented in one or more Application Programming Interfaces (APIs). An API is an interface implemented by a program code component or hardware component (hereinafter “API-implementing component”) that allows a different program code component or hardware component (hereinafter “API-calling component”) to access and use one or more functions, methods, procedures, data structures, classes, and/or other services provided by the API-implementing component. An API can define one or more parameters that are passed between the API-calling component and the API-implementing component.

The above-described features can be implemented as part of an application program interface (API) that can allow it to be incorporated into different applications (e.g., spreadsheet apps) utilizing touch input as an input mechanism. An API can allow a developer of an API-calling component (which may be a third party developer) to leverage specified features, such as those described above, provided by an API-implementing component. There may be one API-calling component or there may be more than one such component. An API can be a source code interface that a computer system or program library provides in order to support requests for services from an application. An operating system (OS) can have multiple APIs to allow applications running on the OS to call one or more of those APIs, and a service (such as a program library) can have multiple APIs to allow an application that uses the service to call one or more of those APIs. An API can be specified in terms of a programming language that can be interpreted or compiled when an application is built.

In some examples, the API-implementing component may provide more than one API, each providing a different view of the functionality implemented by the API-implementing component, or with different aspects that access different aspects of the functionality implemented by the API-implementing component. For example, one API of an API-implementing component can provide a first set of functions and can be exposed to third party developers, and another API of the API-implementing component can be hidden (not exposed) and provide a subset of the first set of functions and also provide another set of functions, such as testing or debugging functions which are not in the first set of functions. In other examples the API-implementing component may itself call one or more other components via an underlying API and thus be both an API-calling component and an API-implementing component.

An API defines the language and parameters that API-calling components use when accessing and using specified features of the API-implementing component. For example, an API-calling component accesses the specified features of the API-implementing component through one or more API calls or invocations (embodied for example by function or method calls) exposed by the API and passes data and control information using parameters via the API calls or invocations. The API-implementing component may return a value through the API in response to an API call from an API-calling component. While the API defines the syntax and result of an API call (e.g., how to invoke the API call and what the API call does), the API may not reveal how the API call accomplishes the function specified by the API call. Various API calls are transferred via the one or more application programming interfaces between the calling (API-calling component) and an API-implementing component. Transferring the API calls may include issuing, initiating, invoking, calling, receiving, returning, or responding to the function calls or messages; in other words, transferring can describe actions by either of the API-calling component or the API-implementing component. The function calls or other invocations of the API may send or receive one or more parameters through a parameter list or other structure. A parameter can be a constant, key, data structure, object, object class, variable, data type, pointer, array, list or a pointer to a function or method or another way to reference a data or other item to be passed via the API.

Furthermore, data types or classes may be provided by the API and implemented by the API-implementing component. Thus, the API-calling component may declare variables, use pointers to, use or instantiate constant values of such types or classes by using definitions provided in the API.

Generally, an API can be used to access a service or data provided by the API-implementing component or to initiate performance of an operation or computation provided by the API-implementing component. By way of example, the API-implementing component and the API-calling component may each be any one of an operating system, a library, a device driver, an API, an application program, or other module (it should be understood that the API-implementing component and the API-calling component may be the same or different type of module from each other). API-implementing components may in some cases be embodied at least in part in firmware, microcode, or other hardware logic. In some examples, an API may allow a client program to use the services provided by a Software Development Kit (SDK) library. In other examples an application or other client program may use an API provided by an Application Framework. In these examples the application or client program may incorporate calls to functions or methods provided by the SDK and provided by the API or use data types or objects defined in the SDK and provided by the API. An Application Framework may in these examples provide a main event loop for a program that responds to various events defined by the Framework. The API allows the application to specify the events and the responses to the events using the Application Framework. In some implementations, an API call can report to an application the capabilities or state of a hardware device, including those related to aspects such as input capabilities and state, output capabilities and state, processing capability, power state, storage capacity and state, communications capability, etc., and the API may be implemented in part by firmware, microcode, or other low level logic that executes in part on the hardware component.

The API-calling component may be a local component (i.e., on the same data processing system as the API-implementing component) or a remote component (i.e., on a different data processing system from the API-implementing component) that communicates with the API-implementing component through the API over a network. It should be understood that an API-implementing component may also act as an API-calling component (i.e., it may make API calls to an API exposed by a different API-implementing component) and an API-calling component may also act as an API-implementing component by implementing an API that is exposed to a different API-calling component.

The API may allow multiple API-calling components written in different programming languages to communicate with the API-implementing component (thus the API may include features for translating calls and returns between the API-implementing component and the API-calling component); however the API may be implemented in terms of a specific programming language. An API-calling component can, in one example, call APIs from different providers such as a set of APIs from an OS provider and another set of APIs from a plug-in provider and another set of APIs from another provider (e.g. the provider of a software library) or creator of the another set of APIs.

FIG. 3 is a block diagram illustrating an exemplary API architecture, which may be used in some examples of the disclosure. As shown in FIG. 3, the API architecture 300 includes the API-implementing component 310 (e.g., an operating system, a library, a device driver, an API, an application program, software or other module) that implements the API 320. The API 320 specifies one or more functions, methods, classes, objects, protocols, data structures, formats and/or other features of the API-implementing component that may be used by the API-calling component 330. The API 320 can specify at least one calling convention that specifies how a function in the API-implementing component receives parameters from the API-calling component and how the function returns a result to the API-calling component. The API-calling component 330 (e.g., an operating system, a library, a device driver, an API, an application program, software or other module), makes API calls through the API 320 to access and use the features of the API-implementing component 310 that are specified by the API 320. The API-implementing component 310 may return a value through the API 320 to the API-calling component 330 in response to an API call.

It will be appreciated that the API-implementing component 310 may include additional functions, methods, classes, data structures, and/or other features that are not specified through the API 320 and are not available to the API-calling component 330. It should be understood that the API-calling component 330 may be on the same system as the API-implementing component 310 or may be located remotely and accesses the API-implementing component 310 using the API 320 over a network. While FIG. 3 illustrates a single API-calling component 330 interacting with the API 320, it should be understood that other API-calling components, which may be written in different languages (or the same language) than the API-calling component 330, may use the API 320.

The API-implementing component 310, the API 320, and the API-calling component 330 may be stored in a non-transitory machine-readable storage medium, which includes any mechanism for storing information in a form readable by a machine (e.g., a computer or other data processing system). For example, a machine-readable medium includes magnetic disks, optical disks, random access memory; read only memory, flash memory devices, etc.

In the exemplary software stack shown in FIG. 4, applications can make calls to Services A or B using several Service APIs and to Operating System (OS) using several OS APIs. Services A and B can make calls to OS using several OS APIs.

Note that the Service 2 has two APIs, one of which (Service 2 API 1) receives calls from and returns values to Application 1 and the other (Service 2 API 2) receives calls from and returns values to Application 2. Service 1 (which can be, for example, a software library) makes calls to and receives returned values from OS API 1, and Service 2 (which can be, for example, a software library) makes calls to and receives returned values from both OS API 1 and OS API 2. Application 2 makes calls to and receives returned values from OS API 2.

FIG. 5 is a block diagram illustrating exemplary interactions between the touch screen and the other components of the device. Described examples may include touch I/O device 1001 that can receive touch input for interacting with computing system 1003 via wired or wireless communication channel 1002. Touch I/O device 1001 may be used to provide user input to computing system 1003 in lieu of or in combination with other input devices such as a keyboard, mouse, etc. One or more touch I/O devices 1001 may be used for providing user input to computing system 1003. Touch I/O device 1001 may be an integral part of computing system 1003 (e.g., touch screen on a smartphone or a tablet PC) or may be separate from computing system 1003.

Touch I/O device 1001 may include a touch sensitive panel which is wholly or partially transparent, semitransparent, non-transparent, opaque or any combination thereof. Touch I/O device 1001 may be embodied as a touch screen, touch pad, a touch screen functioning as a touch pad (e.g., a touch screen replacing the touchpad of a laptop), a touch screen or touchpad combined or incorporated with any other input device (e.g., a touch screen or touchpad disposed on a keyboard) or any multi-dimensional object having a touch sensitive surface for receiving touch input.

In one example, touch I/O device 1001 embodied as a touch screen may include a transparent and/or semitransparent touch sensitive panel partially or wholly positioned over at least a portion of a display. According to this example, touch I/O device 1001 functions to display graphical data transmitted from computing system 1003 (and/or another source) and also functions to receive user input. In other examples, touch I/O device 1001 may be embodied as an integrated touch screen where touch sensitive components/devices are integral with display components/devices. In still other examples a touch screen may be used as a supplemental or additional display screen for displaying supplemental or the same graphical data as a primary display and to receive touch input.

Touch I/O device 1001 may be configured to detect the location of one or more touches or near touches on device 1001 based on capacitive, resistive, optical, acoustic, inductive, mechanical, chemical measurements, or any phenomena that can be measured with respect to the occurrences of the one or more touches or near touches in proximity to device 1001. Software, hardware, firmware or any combination thereof may be used to process the measurements of the detected touches to identify and track one or more gestures. A gesture may correspond to stationary or non-stationary, single or multiple, touches or near touches on touch I/O device 1001. A gesture may be performed by moving one or more fingers or other objects in a particular manner on touch I/O device 1001 such as tapping, pressing, rocking, scrubbing, twisting, changing orientation, pressing with varying pressure and the like at essentially the same time, contiguously, or consecutively. A gesture may be characterized by, but is not limited to a pinching, sliding, swiping, rotating, flexing, dragging, or tapping motion between or with any other finger or fingers. A single gesture may be performed with one or more hands, by one or more users, or any combination thereof.

Computing system 1003 may drive a display with graphical data to display a graphical user interface (GUI). The GUI may be configured to receive touch input via touch I/O device 1001. Embodied as a touch screen, touch I/O device 1001 may display the GUI. Alternatively, the GUI may be displayed on a display separate from touch I/O device 1001. The GUI may include graphical elements displayed at particular locations within the interface. Graphical elements may include but are not limited to a variety of displayed virtual input devices including virtual scroll wheels, a virtual keyboard, virtual knobs, virtual buttons, any virtual UI, and the like. A user may perform gestures at one or more particular locations on touch I/O device 1001 which may be associated with the graphical elements of the GUI. In other examples, the user may perform gestures at one or more locations that are independent of the locations of graphical elements of the GUI. Gestures performed on touch I/O device 1001 may directly or indirectly manipulate, control, modify, move, actuate, initiate or generally affect graphical elements such as cursors, icons, media files, lists, text, all or portions of images, or the like within the GUI. For instance, in the case of a touch screen, a user may directly interact with a graphical element by performing a gesture over the graphical element on the touch screen. Alternatively, a touch pad generally provides indirect interaction. Gestures may also affect non-displayed GUI elements (e.g., causing user interfaces to appear) or may affect other actions within computing system 1003 (e.g., affect a state or mode of a GUI, application, or operating system). Gestures may or may not be performed on touch I/0 device 1001 in conjunction with a displayed cursor. For instance, in the case in which gestures are performed on a touchpad, a cursor (or pointer) may be displayed on a display screen or touch screen and the cursor may be controlled via touch input on the touchpad to interact with graphical objects on the display screen. In other examples in which gestures are performed directly on a touch screen, a user may interact directly with objects on the touch screen, with or without a cursor or pointer being displayed on the touch screen.

Feedback may be provided to the user via communication channel 1002 in response to or based on the touch or near touches on touch I/O device 1001. Feedback may be transmitted optically, mechanically, electrically, olfactory, acoustically, or the like or any combination thereof and in a variable or non-variable manner.

Attention is now directed towards examples of a system architecture that may be embodied within any portable or non-portable device including but not limited to a communication device (e.g. mobile phone, smart phone), a multi-media device (e.g., MP3 player, TV, radio), a portable or handheld computer (e.g., tablet, netbook, laptop), a desktop computer, an All-In-One desktop, a peripheral device, or any other system or device adaptable to the inclusion of system architecture 2000, including combinations of two or more of these types of devices. FIG. 6 is a block diagram of one example of system 2000 that generally includes one or more computer-readable mediums 2001, processing system 2004, I/O subsystem 2006, radio frequency (RF) circuitry 2008, audio circuitry 2010, and gaze detection circuitry 2011. These components may be coupled by one or more communication buses or signal lines 2003.

It should be apparent that the architecture shown in FIG. 6 is only one example architecture of system 2000, and that system 2000 could have more or fewer components than shown, or a different configuration of components. The various components shown in FIG. 6 can be implemented in hardware, software, firmware or any combination thereof, including one or more signal processing and/or application specific integrated circuits.

RF circuitry 2008 is used to send and receive information over a wireless link or network to one or more other devices and includes well-known circuitry for performing this function. RF circuitry 2008 and audio circuitry 2010 are coupled to processing system 2004 via peripherals interface 2016. Interface 2016 includes various known components for establishing and maintaining communication between peripherals and processing system 2004. Audio circuitry 2010 is coupled to audio speaker 2050 and microphone 2052 and includes known circuitry for processing voice signals received from interface 2016 to enable a user to communicate in real-time with other users. In some examples, audio circuitry 2010 includes a headphone jack (not shown).

Peripherals interface 2016 couples the input and output peripherals of the system to processor 2018 and computer-readable medium 2001. One or more processors 2018 communicate with one or more computer-readable mediums 2001 via controller 2020. Computer-readable medium 2001 can be any device or medium that can store code and/or data for use by one or more processors 2018. Medium 2001 can include a memory hierarchy, including but not limited to cache, main memory and secondary memory. The memory hierarchy can be implemented using any combination of RAM (e.g., SRAM, DRAM, DDRAM), ROM, FLASH, magnetic and/or optical storage devices, such as disk drives, magnetic tape, CDs (compact disks) and DVDs (digital video discs). Medium 2001 may also include a transmission medium for carrying information-bearing signals indicative of computer instructions or data (with or without a carrier wave upon which the signals are modulated). For example, the transmission medium may include a communications network, including but not limited to the Internet (also referred to as the World Wide Web), intranet(s), Local Area Networks (LANs), Wide Local Area Networks (WLANs), Storage Area Networks (SANs), Metropolitan Area Networks (MAN) and the like.

One or more processors 2018 run various software components stored in medium 2001 to perform various functions for system 2000. In some examples, the software components include operating system 2022, communication module (or set of instructions) 2024, touch processing module (or set of instructions) 2026, graphics module (or set of instructions) 2028, and one or more applications (or set of instructions) 2030. Each of these modules and above noted applications correspond to a set of instructions for performing one or more functions described above and the methods described in this application (e.g., the computer-implemented methods and other information processing methods described herein). These modules (i.e., sets of instructions) need not be implemented as separate software programs, procedures or modules, and thus various subsets of these modules may be combined or otherwise re-arranged in various examples. In some examples, medium 2001 may store a subset of the modules and data structures identified above. Furthermore, medium 2001 may store additional modules and data structures not described above.

Operating system 2022 includes various procedures, sets of instructions, software components and/or drivers for controlling and managing general system tasks (e.g., memory management, storage device control, power management, etc.) and facilitates communication between various hardware and software components.

Communication module 2024 facilitates communication with other devices over one or more external ports 2036 or via RF circuitry 2008 and includes various software components for handling data received from RF circuitry 2008 and/or external port 2036.

Graphics module 2028 includes various known software components for rendering, animating and displaying graphical objects on a display surface. In examples in which touch I/O device 2012 is a touch sensitive display (e.g., touch screen), graphics module 2028 includes components for rendering, displaying, and animating objects on the touch sensitive display.

One or more applications 2030 can include any applications installed on system 2000, including without limitation, a browser, address book, contact list, email, instant messaging, word processing, keyboard emulation, widgets, JAVA-enabled applications, encryption, digital rights management, voice recognition, voice replication, location determination capability (such as that provided by the global positioning system (GPS)), a music player, etc.

Touch processing module 2026 includes various software components for performing various tasks associated with touch I/O device 2012 including but not limited to receiving and processing touch input received from I/O device 2012 via touch I/O device controller 2032.

I/O subsystem 2006 is coupled to touch I/O device 2012 and one or more other I/O devices 2014 for controlling or performing various functions. Touch I/O device 2012 communicates with processing system 2004 via touch I/O device controller 2032, which includes various components for processing user touch input (e.g., scanning hardware). One or more other input controllers 2034 receives/sends electrical signals from/to other I/O devices 2014. Other I/O devices 2014 may include physical buttons, dials, slider switches, sticks, keyboards, touch pads, additional display screens, or any combination thereof.

If embodied as a touch screen, touch I/O device 2012 displays visual output to the user in a GUI. The visual output may include text, graphics, video, and any combination thereof. Some or all of the visual output may correspond to user-interface objects. Touch I/O device 2012 forms a touch-sensitive surface that accepts touch input from the user. Touch I/O device 2012 and touch screen controller 2032 (along with any associated modules and/or sets of instructions in medium 2001) detects and tracks touches or near touches (and any movement or release of the touch) on touch I/O device 2012 and converts the detected touch input into interaction with graphical objects, such as one or more user-interface objects. In the case in which device 2012 is embodied as a touch screen, the user can directly interact with graphical objects that are displayed on the touch screen. Alternatively, in the case in which device 2012 is embodied as a touch device other than a touch screen (e.g., a touch pad), the user may indirectly interact with graphical objects that are displayed on a separate display screen embodied as I/O device 2014.

Touch I/O device 2012 may be analogous to the multi-touch sensitive surface described in the following U.S. patents: U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference.

Examples in which touch I/O device 2012 is a touch screen, the touch screen may use LCD (liquid crystal display) technology, LPD (light emitting polymer display) technology, OLED (organic LED), or OEL (organic electro luminescence), although other display technologies may be used in other examples.

Feedback may be provided by touch I/O device 2012 based on the user's touch input as well as a state or states of what is being displayed and/or of the computing system. Feedback may be transmitted optically (e.g., light signal or displayed image), mechanically (e.g., haptic feedback, touch feedback, force feedback, or the like), electrically (e.g., electrical stimulation), olfactory, acoustically (e.g., beep or the like), or the like or any combination thereof and in a variable or non-variable manner.

System 2000 also includes power system 2044 for powering the various hardware components and may include a power management system, one or more power sources, a recharging system, a power failure detection circuit, a power converter or inverter, a power status indicator and any other components typically associated with the generation, management and distribution of power in portable devices.

In some examples, peripherals interface 2016, one or more processors 2018, and memory controller 2020 may be implemented on a single chip, such as processing system 2004. In some other examples, they may be implemented on separate chips.

Examples of the disclosure can be advantageous in providing a user with an intuitive and easy-to-use method for automatically scaling an image having text such that the text is legible.

In some examples, a non-transitory computer readable storage medium is disclosed. The medium can have stored therein instructions, which when executed by a mobile device, cause the device to perform a method as described by one or more examples herein.

In some examples, a method of a computing device including a display is disclosed. The method may include obtaining an image having text; obtaining a size of the text; determining a scaling factor based on the size of the text; and displaying the image scaled based on the scaling factor. Additionally or alternatively to one or more of the examples described above, the method may further include displaying a first portion of the image; wherein the text may be located within a second portion of the image, obtaining the size of the text may occur while the first portion of the image is displayed, and displaying the image scaled based on the scaling factor may include displaying the second portion of the image scaled based on the scaling factor. Additionally or alternatively to one or more of the examples described above, obtaining the size of the text may include processing at least a portion of the image to determine an average character height of the text. Additionally or alternatively to one or more of the examples described above, processing at least a portion of the image may include applying optical character recognition to at least a portion of the image. Additionally or alternatively to one or more of the examples described above, the method may further include selecting a portion of the image based on user input; wherein some or all of the text may be located within the selected portion of the image, and displaying the image scaled based on the scaling factor may include displaying the portion of the image scaled based on the scaling factor. Additionally or alternatively to one or more of the examples described above, selecting a portion of the image based on user input may include selecting a scaling focus based on user input, and the portion of the image includes the scaling focus. Additionally or alternatively to one or more of the examples described above, obtaining the size of the text may include determining two sizes of the text and selecting the smaller of the two sizes, and determining the scaling factor may be based on the smaller of the two sizes. Additionally or alternatively to one or more of the examples described above, obtaining the image having text may include obtaining the image as part of a web page. Additionally or alternatively to one or more of the examples described above, the image may comprise a visual representation of the text without storing the text in a character-encoding scheme. Additionally or alternatively to one or more of the examples described above, determining the scaling factor may be further based on a desired text size. Additionally or alternatively to one or more of the examples described above, the desired text size may be determined based on one or more properties of the display. Additionally or alternatively to one or more of the examples described above, the desired text size may be determined based on a legibility factor set by user input.

In some examples, an electronic device is disclosed. The electronic device may include a processor to execute instructions; a display; and a memory coupled with the processor to store instructions, which when executed by the processor, may cause the processor to perform operations to generate an application programming interface (API) that allows an API-calling component to perform the following operations: obtaining an image having text; obtaining a size of the text; determining a scaling factor based on the size of the text; and displaying the image scaled based on the scaling factor. Additionally or alternatively to one or more of the examples described above, the operations may further include displaying a first portion of the image; wherein the text may be located within a second portion of the image, obtaining the size of the text may occur while the first portion of the image is displayed, and displaying the image scaled based on the scaling factor may include displaying the second portion of the image scaled based on the scaling factor. Additionally or alternatively to one or more of the examples described above, obtaining the size of the text may include processing at least a portion of the image to determine an average character height of the text. Additionally or alternatively to one or more of the examples described above, processing at least a portion of the image may include applying optical character recognition to at least a portion of the image. Additionally or alternatively to one or more of the examples described above, the operations may further include selecting a portion of the image based on user input; wherein some or all of the text may be located within the selected portion of the image, and displaying the image scaled based on the scaling factor may include displaying the portion of the image scaled based on the scaling factor. Additionally or alternatively to one or more of the examples described above, selecting a portion of the image based on user input may include selecting a scaling focus based on user input, and the portion of the image may include the scaling focus. Additionally or alternatively to one or more of the examples described above, obtaining the size of the text may include determining two sizes of the text and selecting the smaller of the two sizes, and determining the scaling factor may be based on the smaller of the two sizes. Additionally or alternatively to one or more of the examples described above, obtaining the image having text may include obtaining the image as part of a web page. Additionally or alternatively to one or more of the examples described above, the image may comprise a visual representation of the text without storing the text in a character-encoding scheme. Additionally or alternatively to one or more of the examples described above, determining the scaling factor may be further based on a desired text size. Additionally or alternatively to one or more of the examples described above, the desired text size may be determined based on one or more properties of the display. Additionally or alternatively to one or more of the examples described above, the desired text size may be determined based on a legibility factor set by user input.

Although the disclosed examples have been fully described with reference to the accompanying drawings, it is to be noted that various changes and modifications will become apparent to those skilled in the art. Such changes and modifications are to be understood as being included within the scope of the disclosed examples as defined by the appended claims.

What is claimed is:

1. A method of a computing device including a display, the method comprising:
obtaining an image having text;
obtaining a size of the text;
determining a scaling factor based on the size of the text; and
displaying the image scaled based on the scaling factor.

2. The method of claim 1, further comprising:
displaying a first portion of the image;
wherein the text is located within a second portion of the image, obtaining the size of the text occurs while the first portion of the image is displayed, and displaying the image scaled based on the scaling factor includes displaying the second portion of the image scaled based on the scaling factor.

3. The method of claim 1, wherein obtaining the size of the text includes processing at least a portion of the image to determine an average character height of the text.

4. The method of claim 3, wherein processing at least a portion of the image includes applying optical character recognition to at least a portion of the image.

5. The method of claim 1, further comprising:
selecting a portion of the image based on user input;
wherein some or all of the text is located within the selected portion of the image, and displaying the image scaled based on the scaling factor includes displaying the portion of the image scaled based on the scaling factor.

6. The method of claim 5, wherein selecting a portion of the image based on user input includes selecting a scaling focus based on user input, and the portion of the image includes the scaling focus.

7. The method of claim 1, wherein obtaining the size of the text includes determining two sizes of the text and selecting the smaller of the two sizes, and determining the scaling factor is based on the smaller of the two sizes.

8. The method of claim 1, wherein obtaining the image having text includes obtaining the image as part of a web page.

9. The method of claim 1, wherein the image comprises a visual representation of the text without storing the text in a character-encoding scheme.

10. The method of claim 1, wherein determining the scaling factor is further based on a desired text size.

11. The method of claim 10, wherein the desired text size is determined based on one or more properties of the display.

12. The method of claim 10, wherein the desired text size is determined based on a legibility factor set by user input.

13. An electronic device, comprising:
a processor to execute instructions;
a display; and
a memory coupled with the processor to store instructions, which when executed by the processor, cause the processor to perform operations to generate an application programming interface (API) that allows an API-calling component to perform the following operations:
obtaining an image having text;
obtaining a size of the text;
determining a scaling factor based on the size of the text; and
displaying the image scaled based on the scaling factor.

14. The electronic device of claim 13, the operations further comprising:
displaying a first portion of the image;
wherein the text is located within a second portion of the image, obtaining the size of the text occurs while the first portion of the image is displayed, and displaying the image scaled based on the scaling factor includes displaying the second portion of the image scaled based on the scaling factor.

15. The electronic device of claim 13, wherein obtaining the size of the text includes processing at least a portion of the image to determine an average character height of the text.

16. The electronic device of claim 15, wherein processing at least a portion of the image includes applying optical character recognition to at least a portion of the image.

17. The electronic device of claim 13, the operations further comprising:
selecting a portion of the image based on user input;
wherein some or all of the text is located within the selected portion of the image, and displaying the image scaled based on the scaling factor includes displaying the portion of the image scaled based on the scaling factor.

18. The electronic device of claim 17, wherein selecting a portion of the image based on user input includes selecting a scaling focus based on user input, and the portion of the image includes the scaling focus.

19. The electronic device of claim 13, wherein obtaining the size of the text includes determining two sizes of the text and selecting the smaller of the two sizes, and determining the scaling factor is based on the smaller of the two sizes.

20. The electronic device of claim 13, wherein obtaining the image having text includes obtaining the image as part of a web page.

21. The electronic device of claim 13, wherein the image comprises a visual representation of the text without storing the text in a character-encoding scheme.

22. The electronic device of claim 13, wherein determining the scaling factor is further based on a desired text size.

23. The electronic device of claim 22, wherein the desired text size is determined based on one or more properties of the display.

24. The electronic device of claim 22, wherein the desired text size is determined based on a legibility factor set by user input.
